(19) United States
(12) Patent Application Publication
(10) Pub. No.: US 2007/0231148 A1
(43) Pub. Date: Oct. 4, 2007

(54) Reversing free flow propeller turbine

(76) Inventor: Kalman N. Lehoczky, Palmetto, FL (US)

Correspondence Address: KALMAN N. LEHOCZKY, 4411 16TH AVE. EAST, PALMETTO, FL, 34221, US

(21) Appl. No.: 11/395,966

(22) Filed: Apr. 3, 2006

(51) Int. Cl. B64C 27/46

(52) U.S. Cl. 416/223 R

(57) ABSTRACT

Free flow axial propeller turbine submerged in free flowing current which may reverse its flow direction equipped with propeller blade profile having similar geometry both at the leading and trailing edge and the profile's centerline's deviation from the straight base line connecting the leading and trailing edge of the profile is in the opposing direction in the profile's section close to the leading edge and the trailing edge respectively.

### A. BACKGROUND OF THE INVENTION

1. Field of Invention

This invention relates to free flow axial propeller turbines utilizing the kinetic energy of free flowing current, which may perform cyclic reversals. The current reversal is typical for tidal currents in the ocean and most noticeable and important in coastal areas with islands, bays and fjords.

2. Description of the Prior Art

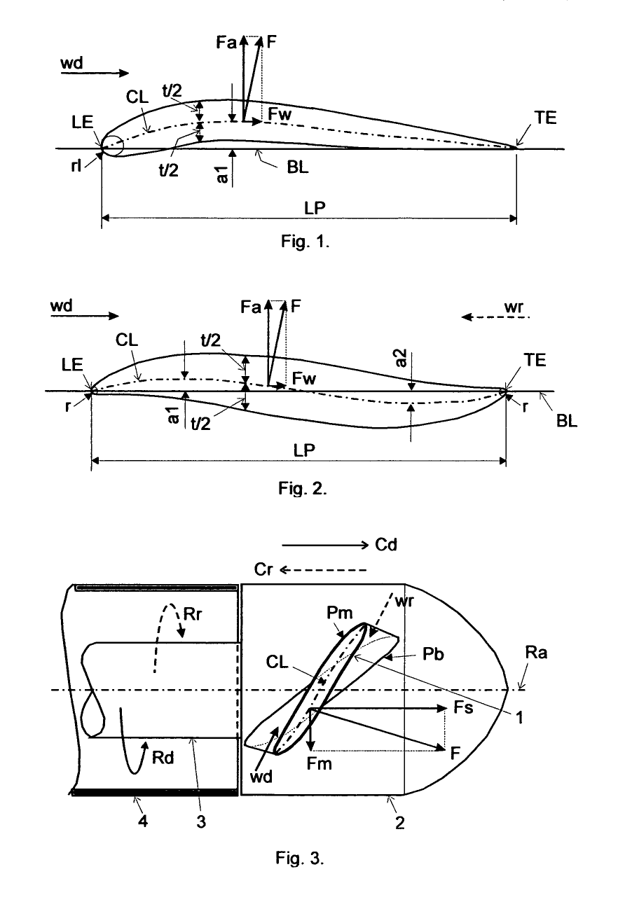

The conventional free flow turbine blade's profile also called foil cross-section, is shown in FIG. 1. In relation to the flow velocity vector, wd, the profile has a length of LT along a base line, BL, connecting the leading edge, LE, and the trailing edge, TE. The profile has a so called center line, CL, which is at the half way thickness, t/2, of the profile measured perpendicular to the straight line connecting the leading edge, LE and trailing edge, TE. Typically, the center line, CL, is not straight line but has a deviation, a1, in relation to the base line, BL. Furthermore, the typical profile has a relative large leading edge radius, rl, and a relative sharp trailing edge. A profile like this is typically unidirectional with respect to the flow direction, wd, creating a large low pressure, suction, above the profile (convex side) and a somewhat smaller high pressure below the profile (concave side). The sum of the suction on the convex side and the pressure on the concave side distributed over the whole length of the profile and over the whole radial length of the propeller blade creates a force component named “lift”, Fa, approximately perpendicular to the base line, BL. There is another force, the “drag”, Fw, due to the flow resistance acting parallel with the base line, BL. The lift force, Fa, and drag force, Fw, can be combined as vectors to supply the total force, F. Since, the propeller blades are typically arranged with profiles having an angle to the blade's rotational movement, therefore, the total force, F, can be decomposed into two force components. One is in the direction of blade movement, Fm, and the other is in the axial direction of the propeller shaft, Fs. Only the force component, Fm, is useful from the point of view of energy production since this component creates the shaft torque.

If the flow direction reverses, for example due to the changing tidal flow, the performance of the conventional profile would become extremely poor, thus the lift/drag relation Fa/Fw would be dramatically reduced. Therefore, one of the existing design for free flow turbines utilizing the kinetic energy of reversing currents is based on a suspension which permits the turbine unit as a whole to turn 180 degree in the horizontal plane. This is achieved by having a vertical pole which may be driven into the bottom of the flow channel and the whole turbine unit, consisting of the propeller and the housing also called nacelle or torpedo containing the drive train, thus bearings, speed-increasing gear, electric generator and auxiliary equipment, can turn around the pole to line up with the changing flow direction like a whether-cock. The problem with this arrangement is that the electric cable transporting the energy from the generator to the shore may be wind up and break if the repeating turning of the turbine unit around the pole occurs in the same rotational direction. Using collector rings and brushes to transfer the electric energy from the turning turbine unit to the stationary pole and stationary cable system consumes non-negligible electrical losses and the inevitable maintenance, such as replacement of the brushes, in a subsurface system significantly increases the operational costs.

Another problem with the whether-cock type of operation that the experience shows, that reversing tidal current does not turn exactly by 180 degree. The turning angle is random and observations showed that it might vary between 150 and 210 degree. If the consideration to the electrical cables caused a forced limitation of the unit's turning angle for example to 170 degree, the reversed current's flow direction may block the turbine in a position which reflects the current direction before the reversal, thus the unit operates in an adverse direction till a random change of the flow direction would violently throw around the whole unit.

Another method of adaptation to the flow reversals is to make the propeller blades adjustable, similar to the so called variable pitch propellers and change the pitch by 180 dgr when the flow reversal occurs. The mechanical components needed to rotate the blades by 180 degree are complicated and the costs are huge especially if the drive system, for example hydraulics, is added. An underlying consideration is, that the variable pitch blade system has less mechanical strength, endurance and much higher maintenance costs compared than the fixed blade system.

The objective of this invention is to avoid the above limitations and shortcomings by designing an improved propeller blade system that safely and economically operates at reversing flow conditions. The main objective of the invention is the application of a bi-directional profile which operates with the best possible performance, Fa/Fw, ratio.

### B BRIEF SUMMARY OF INVENTION

Briefly stated, in accordance with one aspect of the present invention free flow axial propeller turbine submerged in free flowing current which may reverse its flow direction is characterized by propeller blade profiles having similar geometry both at the leading and trailing edge and the profile's centerline's deviation from the base line connecting the leading and trailing edge of the profile is in the opposing direction in the profile's section close to the leading edge and the trailing edge respectively.

Other features of the invention will be described in connection with the drawing.

### C BRIEF DESCRIPTION OF THE SEVERAL VIEWS OF THE DRAWINGS

The drawing contains three (3) figures. In order to clarify certain basic terms FIG. 1 shows the prior art with respect to the unidirectional propeller blade profile. FIG. 2 shows the bi-directional propeller blade profile in accordance with the present invention. FIG. 3 shows the assembly of a free flow axial propeller turbine equipped with the bi-directional blade profiles permitting the operation of the turbine with occasionally reversing current.

### D DETAILED DESCRIPTION OF THE INVENTION

FIG. 1 shows the conventional shape of the profile also called “foil cross-section” in order to explain some basic features and terminology. The relevant description is presented in the Section Description of Prior Art. FIG. 2 show a possible bi-directional design in accordance with this invention. The initial direction of the local relative flow is cd. The profile's leading edge, LE, where it meats the relative flow while at the trailing edge, TE, where the flow leaves the profile. A straight base line, BL, connects the leading and trailing edge, LE and TE. The distance in flow direction between the leading, LE, and trailing, TE, edge is the length of the profile, LP. The thickness of the profile is t. The half thickness, t/2, defines the centerline, CL, of the profile. The centerline, CL, of the profile may deviate from the base line, BL. If there is a deviation, in accordance with this invention the deviation, a1, in the first section of the profile and the deviation, a2, in the second section of the profile is in opposing direction in relation to the base line, BL. These deviations can be zero or larger than zero but the arch defined by the deviations shall not be on the same side of the base line, BL.

When the current reverses, the flow velocity vector will turn for example 180 degree into a direction indicated with the dashed arrow, cr. That means, the profile's former leading edge, LE, will become a trailing edge, and the former trailing edge, TE, will operate as leading edge. Therefore, it would be logical if the rounding radius, r, at the leading, LE, and trailing, TE, edge would be about the same size but smaller than that at the leading edge, LE, of the unidirectional profile.

The bi-directional profile may not have the same performance, Fa/Fw, or efficiency as the unidirectional profile. However, the manufacturing, installation and most of all the maintenance costs of the device necessary to turn the propeller turbine with unidirectional profiles or the 180 degree blade turning far outweighs the energy loss in the bi directional propeller turbine.

The bi-directional profile in accordance with this invention would be applied to the blade 1 of the propeller turbine as shown in FIG. 3. The propeller hub 2 caries the blades 1. The number of blades is not limited by this invention. The hub 2 is mounted on the propeller shaft 3 that is supported in bearings in the non-rotating housing 4 also called nacelle or torpedo housing.

The angle between the propeller's rotational plan and the profile should decrease gradually along the blade 1 from the hub to outermost radial end of the propeller blade 1. FIG. 1. indicates the bottom profile, Pb, at the hub 2 and a profile, Pm, in median radial distance between the hub 2 and the outermost end of the blade 1. The profile's centerline has the same interpretation as before and marked CL.

Vector F represents the resulting hydrodynamic force acting on the Pm profile. This force has two components: Component, Fs, is a force parallel with the rotation axis, Ra, loading the propeller turbine's axial thrust bearing. Component, Fm, is a tangential force creating the torque driving the free flow turbine's rotating parts. The integral of Fm forces for the fill radial length of the blade, 1, is the useful part of the propeller's hydraulic performance.

Assuming a current flow direction, Cd, creating a local relative flow velocity, wd, at the profile, Pm, the shaft rotational direction will be Rd. When the flow reverses to Cr the relative flow at profile, Pm, switches to wr and the rotational direction to Rr.

The bi-directional profile in accordance with this invention may have any value equal or greater than zero for deviation, a1 and a2, as well as any thickness, t, and any leading and trailing edge radius, r, without limiting the validity of the invention. Similarly, the invention is not limited by the number of propeller blades per propeller turbine runner or by the variation of the blade with, LP, or by the angle of the blade in relation to the rotation axis, Ra, or by the blade's deviation from the radial straight line.

Considering, that the flow reversal may not happen with exactly 180 dgr, therefore, the axial direction of the turbine unit represented by the rotational axis, Ra, may be corrected in accordance with this invention by application of a mechanical turning device driven by hydrostatic, hydrodynamic or electric actuators turning the whole turbine unit in relation to the stationary support structure, for example a vertical pole.

In accordance with this invention, the efficiency of the free flow axial propeller turbine can be improved by application of adjustable guide vanes or structures acting as guide vanes influencing the rotation of the current around the rotational axis Ra before the current enters or after the current exits the propeller. The adjustment of the for or after rotation causes that the propeller blade's profile maintain a high performance indicated by the Fa/Fw relation in spite of the current's changing volume and velocity.

What is claimed is:

1. Free flow axial propeller turbine utilizing the kinetic energy of free flowing currents which may reverse its flow direction is characterized by blade profile having similar geometry both at the leading and trailing edge and the profile's centerline's deviation if any from the base line connecting the leading and trailing edge of the profile is in the opposing direction in the profile's section close to the leading edge and the trailing edge respectively.

2. Free flow axial propeller turbine in accordance with claim 1 characterized by being equipped with a mechanical turning device which turns the whole free flow axial propeller turbine unit to line up with the free flowing current.

3. Free flow axial propeller turbine in accordance with any of the preceding claims is equipped with structures acting as guide vanes causing the current to rotate around the free flow axial propeller turbine's rotational axis before the current enters the free flow axial propeller turbine's propeller.
